(19) United States
(12) Patent Application Publication
(10) Pub. No.: US 2026/0260359 A1
(43) Pub. Date: Sep. 3, 2026

(54) AMODAL OBJECT SEGMENTATION AND SYNTHETIC AMODAL DATA GENERATION

(71) Applicant: NVIDIA CORPORATION, Santa Clara, CA (US)

(72) Inventors: Cheng SUN, Hsinchu City (TW); Hwann-Tzong CHEN, Hsinchu City (TW); Yu-Lin SHIH, Taichung City (TW); Wei-En TAI, Hsinchu City (TW); Yu-Chiang WANG, Taipei (TW)

(21) Appl. No.: 19/410,873

(22) Filed: Dec. 5, 2025

Related U.S. Application Data
(60) Provisional application No. 63/765,409, filed on Feb. 28, 2025.

(51) Int. Cl. G06T 7/12; G06N 20/00; G06T 5/50; G06T 11/60; G06V 10/25

(52) U.S. Cl. CPC G06T 7/12; G06N 20/00; G06T 5/50; G06T 11/60; G06V 10/25; G06T 2207/20221

(57) ABSTRACT

The disclosed method for training a machine learning model for image segmentation includes generating, based on one or more first images and one or more first bounding box prompts, and using a first trained machine learning model, a first predicted amodal mask; generating, based on the first predicted amodal mask, the one or more first images, the one or more first bounding box prompts, and one or more ground truth modal masks, unoccluded object data; generating, based on the unoccluded object data, one or more synthetic images and occluded object data; and performing, based on the one or more synthetic images and the occluded object data, one or more operations to train a second machine learning model to generate a second trained machine learning model, where the second trained machine learning model processes a second image and a second bounding box prompt to generate a second predicted amodal mask.

### CROSS-REFERENCE TO RELATED APPLICATIONS

This application claims priority benefit of the United States Provisional Patent Application titled, “TECHNIQUES FOR AMODAL INSTANCE SEGMENTATION,” filed on Feb. 28, 2025, and having Ser. No. 63/765,409. The subject matter of this related application is hereby incorporated herein by reference.

### BACKGROUND

### Technical Field

Embodiments of the present disclosure relate generally to computer science, artificial intelligence, and machine learning and, more specifically, to amodal object segmentation and synthetic amodal data generation.

### Description of the Related Art

In computer vision, object segmentation refers to dividing an image into distinct regions or segments to define the boundaries of objects within the image at a pixel level. Mask prediction is one form of object segmentation that involves determining the pixel-wise region occupied by an object in an image. Modal mask prediction and amodal mask prediction are two different mask prediction tasks. In modal mask prediction, the portion of an object that is visible to the camera is identified, which is the portion that is unobstructed by other objects or scene elements. In amodal mask prediction, the prediction extends beyond the visible boundaries to include hidden or occluded regions of the object, representing the complete physical extent of the object. A modal mask therefore describes what is directly observed, while an amodal mask describes the full object, including unseen portions. Amodal mask prediction is useful in many computer vision applications, such as detecting vehicles and pedestrians in autonomous driving, identifying graspable objects in robotic manipulation, reconstructing partially visible items in augmented or virtual reality, estimating the full shape of organs and instruments in medical imaging, and/or the like.

Conventional approaches for amodal mask prediction use machine learning models (e.g., amodal mask prediction models) trained to infer the full extent of objects from partially visible images. Amodal training data used to train the machine models typically includes images paired with amodal annotations, where the complete object outline is labeled, enabling the machine learning model to learn correlations between visible boundaries and hidden regions. For example, the training data could include human-annotated datasets that closely represent real-world scenes or include synthetic datasets generated to simulate occlusion conditions. Conventional amodal mask prediction models are trained jointly with an object detector and a mask decoder, allowing the object detector to localize objects and the mask decoder to infer the complete shapes. For example, in an image of a person standing behind a desk, a conventional amodal mask prediction model can infer the lower body of the person based on learned patterns of human shape, continuity, and contextual relationships among objects in the image.

One drawback of the above approaches for amodal mask prediction lies in the limitations of the amodal training data used for training. Human-annotated datasets, while closely reflecting real-world scenes, are costly to produce and subject to human error, particularly when estimating the extent of occluded regions. Synthetic datasets, on the other hand, can be generated efficiently but often lack reliable mechanisms to verify whether objects are complete and fail to represent realistic occlusion patterns.

Another drawback of the above approaches is that the training of amodal mask prediction models typically includes joint training of both the object detector and the mask decoder, which prevents amodal mask prediction models from fully leveraging powerful pre-trained modal detectors. Because the amodal and modal components are coupled, improvements or updates in one component cannot easily transfer to the other component, leading to redundant training and reduced modularity. The dependency restricts scalability and hinders the reuse of high-performing modal mask prediction models, such as modal mask prediction models already trained on large-scale datasets for visible object detection.

As the foregoing illustrates, what is needed in the art are more effective techniques for amodal mask prediction and synthetic amodal training data generation.

### SUMMARY

According to some embodiments, a computer-implemented method for training a machine learning model for image segmentation includes generating, based on one or more first images and one or more first bounding box prompts, and using a first trained machine learning model, a first predicted amodal mask. The method also includes generating, based on the first predicted amodal mask, the one or more first images, the one or more first bounding box prompts, and one or more ground truth modal masks, unoccluded object data. The method further includes generating, based on the unoccluded object data, one or more synthetic images and occluded object data. Furthermore, the method includes performing, based on the one or more synthetic images and the occluded object data, one or more operations to train a second machine learning model to generate a second trained machine learning model, where the second trained machine learning model processes a second image and a second bounding box prompt to generate a second predicted amodal mask.

Further embodiments provide, among other things, non-transitory computer-readable storage media storing instructions and systems configured to implement the method set forth above.

At least one technical advantage of the disclosed techniques relative to the prior art is that the disclosed techniques improve the generation of synthetic amodal training data by generating synthetic images that more accurately capture realistic occlusion relationships among objects. Unlike conventional synthetic datasets that lack reliable mechanisms for verifying object completeness, the disclosed techniques generate synthesized images with built-in consistency checks, ensuring that the synthesized images reflect plausible real-world visibility and occlusion conditions. In addition, the disclosed techniques decouple the amodal mask prediction component from the modal detection component, allowing the amodal mask decoder to leverage pretrained modal detectors without redundant joint training. As a result, the disclosed techniques can automatically generate large quantities of high-quality synthetic amodal training data, which can in turn be used to train machine learning models that correctly predict amodal masks for input images. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 illustrates how the model trainer of FIG. 1 trains an amodal mask prediction model, according to various embodiments;

FIG. 4 is a more detailed illustration of the synthetic amodal data generator of FIG. 1, according to various embodiments;

FIG. 5 illustrates how the model trainer of FIG. 1 retrains a trained amodal mask prediction model, according to various embodiments;

FIG. 6 is a more detailed illustration of the amodal mask generation application of FIG. 1, according to various embodiments;

FIG. 7 is a flow diagram of method steps for training an amodal mask prediction model, generating synthetic amodal training data, and retraining a trained amodal mask prediction model, according to various embodiments;

FIG. 8 is a flow diagram of method steps for training an amodal mask prediction model, according to various embodiments;

FIG. 9 is a flow diagram of method steps for generating synthetic amodal training data, according to various embodiments;

FIG. 10 is a flow diagram of method steps for retraining a trained amodal mask prediction model, according to various embodiments; and

FIG. 11 is the flow diagram of method steps for generating a predicted amodal mask, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for amodal mask prediction and synthetic amodal data generation. In some embodiments, an amodal mask prediction model is a machine learning model, such as a neural network, that processes an image and a bounding box prompt and generates a predicted amodal mask and a prediction confidence. The amodal mask prediction model includes an image encoder, a prompt encoder, and a mask decoder. The image encoder is another machine learning model, such as a neural network, that processes the image and generates an image embedding. The prompt encoder is yet another machine learning model, such as a neural network, that processes the bounding box prompt and generates a prompt embedding. The mask decoder is still another machine learning model that processes the image embedding and the prompt embedding and generates a mask embedding. In some embodiments, a model trainer trains the amodal mask prediction model based on amodal training data. During training, the image encoder processes an image included in the amodal training data and generates the image embedding. The prompt encoder processes a prompt included in the amodal training data and generates the prompt embedding. The mask decoder processes the image embedding and the prompt embedding and generates the mask embedding. The amodal mask prediction model processes the mask embedding and generates the predicted amodal mask and the prediction confidence. A loss calculator calculates a loss based on the predicted amodal mask, the prediction confidence, and a ground truth amodal mask included in the amodal training data. The model trainer uses the loss to update the parameters of the mask decoder iteratively until one or more stopping criteria are met.

In some embodiments, a synthetic amodal data generator uses a trained amodal mask prediction model to generate synthetic amodal training data based on modal training data. The synthetic amodal data generator includes an unoccluded object data generator and an occluded object data generator. During the data generation, the synthetic amodal data generator uses the trained amodal mask prediction model to process an image included in the modal training data and a prompt included in the modal training data and generates the predicted amodal mask. The unoccluded object data generator processes the predicted amodal mask, the image, the prompt, and a ground truth modal mask included in the modal training data and generates unoccluded object data that includes an image crop, a full amodal mask, and a visible modal mask. The occluded object data generator processes the unoccluded object data and generates synthesized images and occluded object data by sampling one or more objects from the unoccluded object data and creating synthetic occlusions by compositing pairs of the objects to simulate real-world overlap conditions at varying occlusion ratios. The synthetic amodal data generator then stores the unoccluded object data and the synthesized images and occluded object data in synthetic amodal training data. The synthetic amodal data generator continues generating synthetic amodal training data until one or more stopping criteria are met.

In some embodiments, the model trainer retrains the trained amodal mask prediction model based on the synthetic amodal training data. During the retraining, the image encoder processes an image included in the synthetic amodal training data and generates the image embedding. The prompt encoder processes a bounding box prompt included in the synthetic amodal training data and generates the prompt embedding. The mask decoder processes the image embedding and the prompt embedding and generates the mask embedding. The trained mask prediction model processes the mask embedding and generates the predicted amodal mask and a prediction confidence. The loss calculator calculates a loss based on the predicted amodal mask, the prediction confidence, and a ground truth amodal mask included in the synthetic amodal training data. The model trainer uses the loss to update the parameters of the trained mask decoder iteratively until one or more stopping criteria are met. Once retrained, the trained amodal mask prediction model can be deployed using an amodal mask generation application to process an input image and optionally a user prompt and generate the predicted amodal mask.

The amodal mask prediction techniques of the present disclosure have many real-world applications. For example, the disclosed techniques can be used in autonomous driving to estimate the full shape of vehicles, pedestrians, or other road users that are partially occluded by obstacles or other vehicles. As another example, the disclosed techniques can be applied in robotic manipulation to infer the complete geometry of objects that are stacked, cluttered, or partially covered, enabling more reliable grasping and motion planning. In augmented and virtual reality, the disclosed techniques can improve scene realism by allowing virtual objects to correctly interact with or appear behind real-world objects. The disclosed techniques can also be applied in medical imaging, industrial inspection, or surveillance systems, where reasoning about occluded structures provides more complete visual understanding and decision-making.

The above examples are not in any way intended to be limiting. As persons skilled in the art will appreciate, as a general matter, the amodal mask prediction techniques described herein can be implemented in any suitable application.

### System Overview

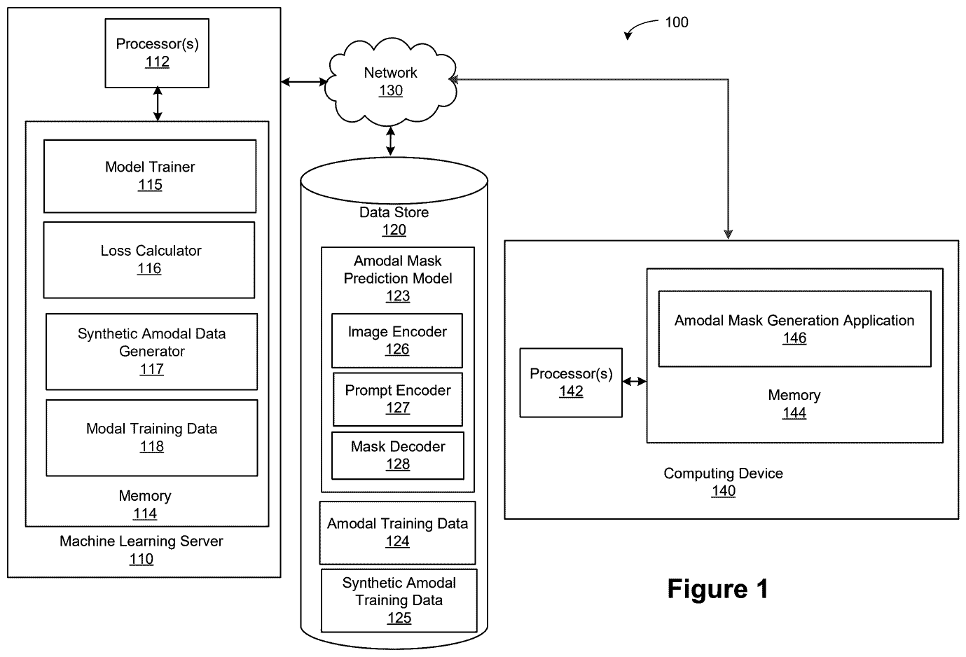

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a loss calculator 116, a synthetic amodal data generator 117, and modal training data 118. Data store 120 includes, without limitation, an amodal mask prediction model 123, amodal training data 124, and synthetic amodal training data 125. Amodal mask prediction model 123 includes, without limitation, an image encoder 126, a prompt encoder 127, and a mask decoder 128. Computing device 140 includes, without limitation, processor(s) 142 and a memory 144. Memory 144 includes, without limitation, an amodal mask generation application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 114 of machine learning server 110 stores content, such as software applications and data, for use by processor(s) 112 and the GPU(s) and/or other processing units. Memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of memories 114, and/or the number of applications included in memory 114 can be modified as desired. Further, the connection topology between the various units in FIG. 1 can be modified as desired. In some embodiments, any combination of processor(s) 112, memory 114, and/or GPU(s) can be included in and/or replaced with any type of virtual computing system, distributed computing system, and/or cloud computing environment, such as a public, private, or a hybrid cloud system.

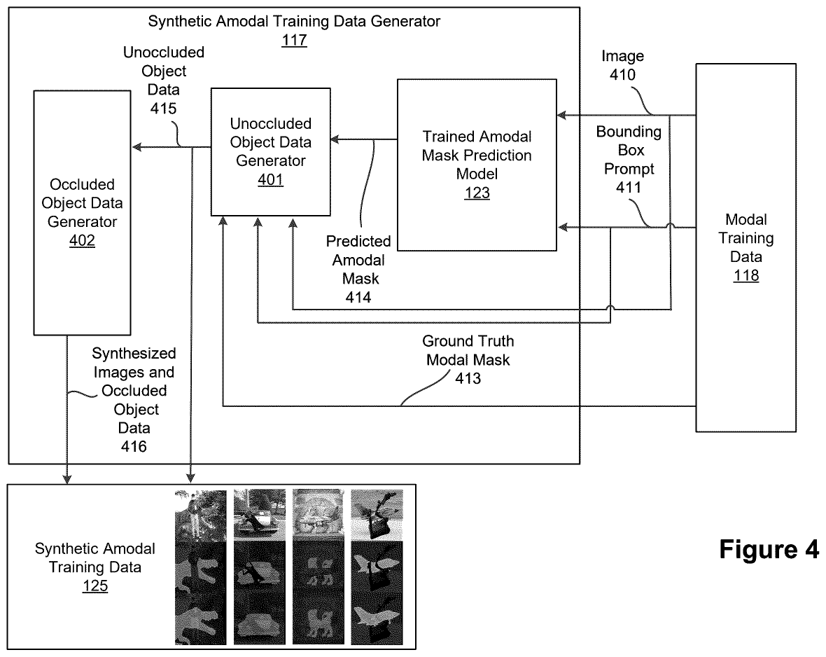

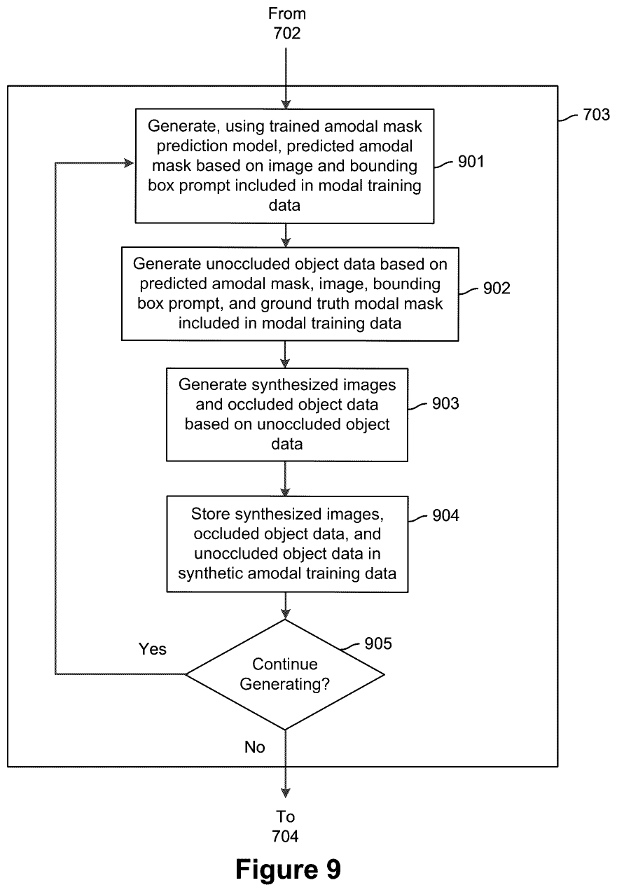

As shown, synthetic amodal data generator 117 executes on one or more processors 112 of machine learning server 110 and is stored in memory 114 of machine learning server 110. In some embodiments, synthetic amodal data generator 117 is an application that uses a trained amodal mask prediction model 123 to process modal training data 118 and generate synthetic amodal training data 125. Modal training data 118 stored in memory 114 includes, without limitation, one or more images, bounding box prompts, and corresponding ground-truth modal masks. Each bounding box prompt includes a bounding box or other region specification identifying a target object. In some examples, modal training data 118 can include existing segmentation datasets, such as the Common Objects in Context (COCO) dataset or the Large Vocabulary Instance Segmentation (LVIS) dataset, both of which provide annotations for visible object regions but lack amodal annotations. Amodal synthetic training data 125 stored in data store 120 and accessed over network 130 includes, without limitation, occluded object data and unoccluded object data (e.g., dual-annotated training examples) that include both visible (e.g., modal) and complete (e.g., amodal) representations of objects. Each example included in synthetic amodal training data 125 includes an image, one or more bounding box prompts, a ground-truth modal mask showing the visible portion of the object, and a corresponding ground-truth amodal mask representing the physical extent of the object, including occluded regions. Synthetic amodal data generator 117 is described in greater detail herein in conjunction with at least FIGS. 4 and 9.

As shown, loss calculator 116 executes on one or more processors 112 of machine learning server 110 and is stored in memory 114 of machine learning server 110. In various embodiments, loss calculator 116 is an application that calculates a loss based on a predicted modal mask, a prediction confidence, and a ground truth amodal mask.

As shown, model trainer 115 is an application that executes on one or more processors 112 of machine learning server 110 and is stored in memory 114 of machine learning server 110. Although shown as distinct from loss calculator 116 for illustrative purposes, in some embodiments, functionality of loss calculator 116 and model trainer 115 can be combined into a single application or separated into any number of applications.

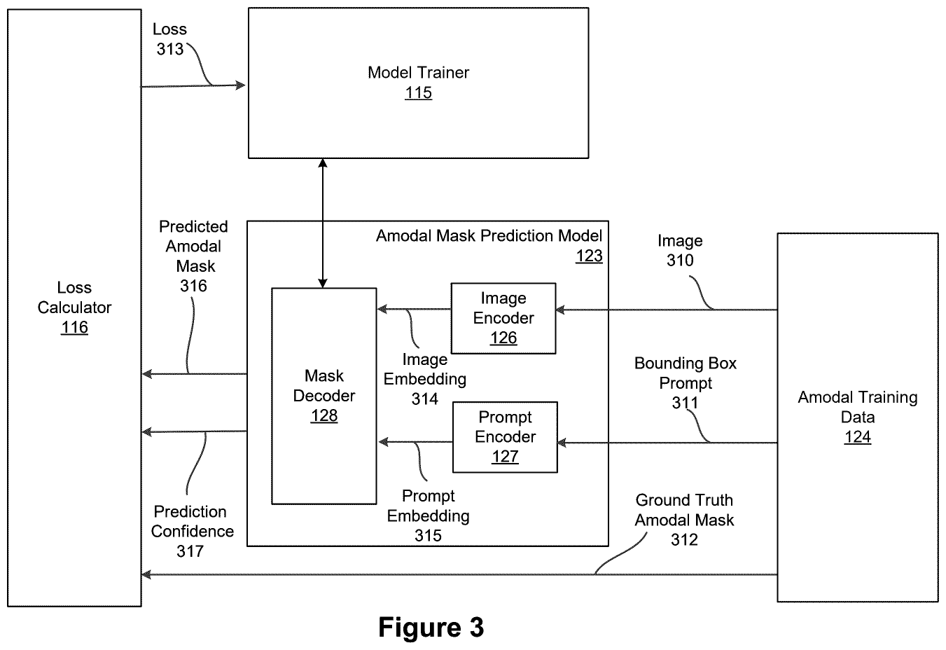

In some embodiments, model trainer 115 is configured to train and/or retrain one or more machine learning models, including amodal mask prediction model 125. Amodal mask prediction model 125 is a machine learning model, such as a neural network, which is trained to generate the predicted amodal mask and the prediction confidence based on an image and a bounding box prompt. Techniques for training amodal mask prediction model 125 based on amodal training data 124 and retraining amodal mask prediction model 125 based on synthetic amodal training data 125 are discussed in greater detail herein in conjunction with at least FIGS. 3, 5, 7, 8, and 10. Amodal training data 124 stored in data store 120 includes, without limitation, one or more images, bounding box prompts, and corresponding ground-truth amodal masks. In some examples, amodal training data 124 can include manually annotated datasets, such as the COCO Amodal (COCOA) dataset, the Depth in the Wild with Segmentation Annotations (D2SA) dataset, or other amodal segmentation datasets that provide annotated examples of complete object boundaries. Amodal mask prediction model 125 can be stored in data store 120. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

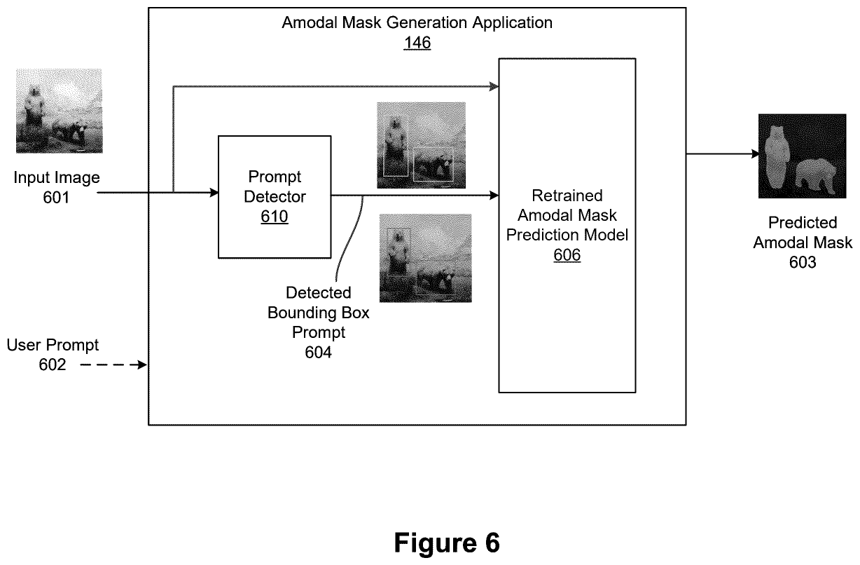

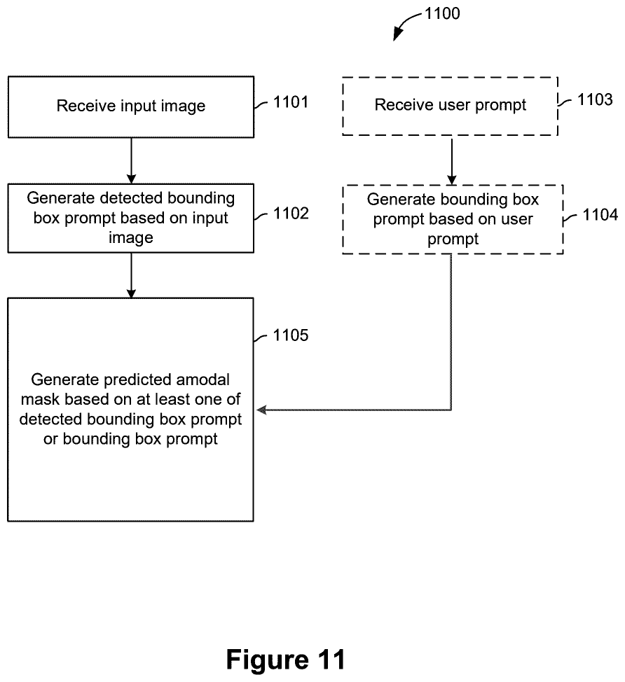

As shown, an amodal mask generation application 146 uses amodal mask prediction model 123, which is stored in data store 120 and accessed over network 130 or included in amodal mask generation application 146, and executes on processor(s) 142, of computer device 140. Once retrained, the retrained amodal mask prediction model can be deployed, such as via amodal mask generation application 146, to generate a predicted amodal mask. Memory 144 and the processor(s) 142 can be similar to memory 114 and processor(s) 112 of machine learning server 110, described above. Amodal mask generation application 146 is discussed in greater detail below in conjunction with FIGS. 6 and 11.

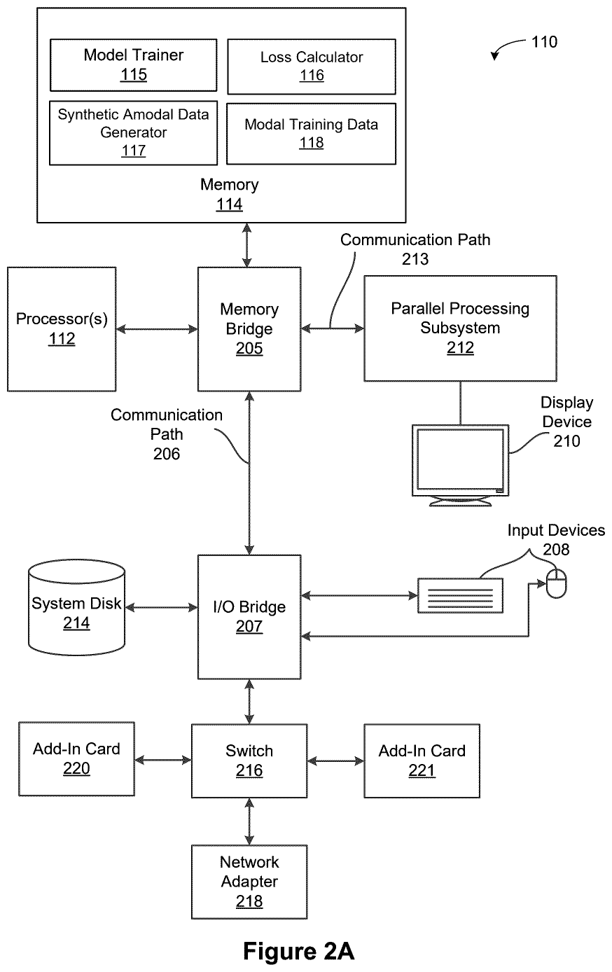

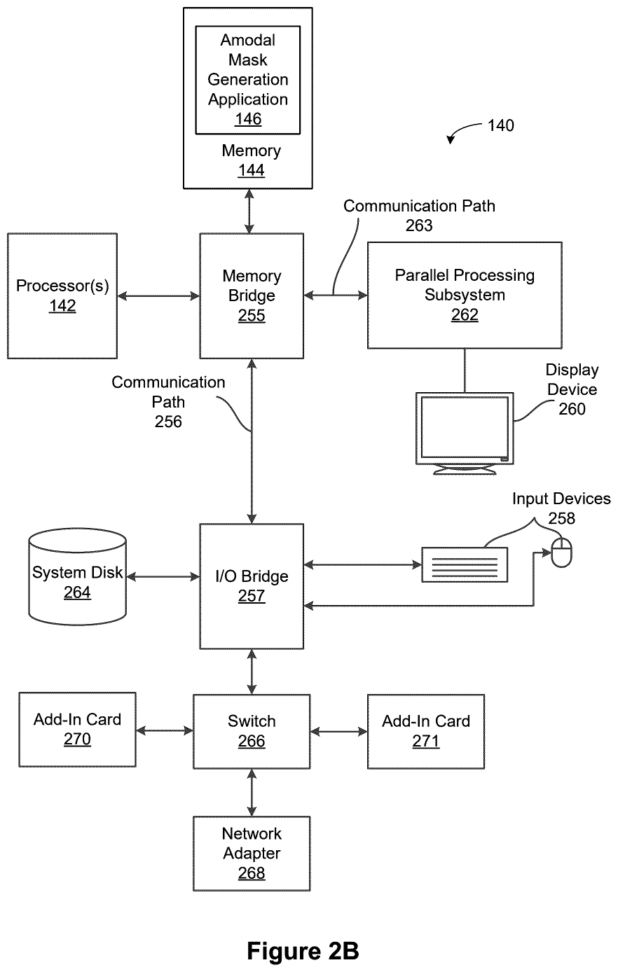

FIG. 2A is a more detailed illustration of machine learning server 110 of FIG. 1, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In some embodiments, I/O bridge 207 is configured to receive user input information from optional input devices 208, such as a keyboard, mouse, touch screen, sensor data analysis (e.g., evaluating gestures, speech, or other information about one or more users in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. Memory 114 includes at least one device driver configured to manage the processing operations of the one or more PPUs within parallel processing subsystem 212. In addition, memory 114 includes, without limitation, model trainer 115, loss calculator 116, synthetic amodal data generator 117, and modal training data 118. Although described herein primarily with respect to model trainer 115, loss calculator 116, synthetic amodal data generator 117, and modal training data 118, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, memory 114 could be connected to the processor(s) 112 directly rather than through memory bridge 205, and other devices may communicate with memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a more detailed illustration of computing device 140 of FIG. 1, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In some embodiments, I/O bridge 257 is configured to receive user input information from optional input devices 258, such as a keyboard, mouse, touch screen, sensor data analysis (eg, evaluating gestures, speech, or other information about one or more users in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In some embodiments, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. Memory 144 includes at least one device driver configured to manage the processing operations of the one or more PPUs within parallel processing subsystem 262. In addition, memory 144 includes amodal mask generation application 146. Although described herein primarily with respect to amodal mask generation application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, memory 144 could be connected to processor(s) 142 directly rather than through memory bridge 255, and other devices may communicate with memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Amodal Mask Prediction Model Using Amodal Training Data

FIG. 3 illustrates how model trainer 115 trains amodal mask prediction model 123, according to various embodiments. As shown, amodal mask prediction model 123 includes, without limitation, an image encoder 126, a prompt encoder 127, and a mask decoder 128. In operation, image encoder 126 processes image 310 included in amodal training data 124 and generates an image embedding 314. Prompt encoder 127 processes bounding box prompt 311 included in amodal training data 124 and generates a prompt embedding 315. Mask decoder 128 processes image embedding 314 and prompt embedding 315 and generates a mask embedding. Amodal mask prediction model 123 processes the mask embedding and generates a predicted amodal mask 316 and a prediction confidence 317. Loss calculator 116 calculates a loss 313 based on predicted amodal mask 316, prediction confidence 317, and ground truth amodal mask 312 included in amodal training data 124. Model trainer 115 uses loss 313 to update the parameters of mask decoder 128 iteratively until one or more stopping criteria are met.

Amodal mask prediction model 123 processes image 310 and bounding box prompt 311 and generates predicted amodal mask 316 and prediction confidence 317. In some embodiments, amodal mask prediction model 123 includes a lightweight image encoder 126 ε, a transformer-based prompt encoder 127 [symbol] , and a mask decoder 128 [symbol] with dual cross-attention layers. In some embodiments, amodal mask prediction model 123 can be initialized to a pre-trained segmentation model that is able to perform modal mask prediction, and the pre-trained segmentation model is further trained to perform the amodal mask prediction task. Given an input image 310 I and a bounding box prompt 311 B, amodal mask prediction model 123 predicts amodal mask 316 \hat{M} and the estimated Intersection-over-Union (IoU) \hat{ρ} included in prediction confidence 317, for example, as described in Equation 1.

$$\hat{M} , \hat{ρ} = 𝒟 ( ℰ ( I ) , 𝒫 ( B ) ) . \qquad ( Equation 1 )$$

Image encoder 126 is a trained machine learning model, such as a neural network, which processes image 310 and generates image embedding 314. In some embodiments, image encoder 126 includes, without limitation, a convolutional neural network (CNN), a vision transformer (ViT), and/or the like. When implemented as a convolutional neural network, image encoder 126 extracts hierarchical visual features, such as edges, shapes, and object parts using convolutional and pooling layers. When implemented as a vision transformer, image encoder 126 divides image 310 into patches and uses self-attention mechanisms to model relationships between distant regions of image 310, improving scene-level understanding.

Prompt encoder 127 is a trained machine learning model, such as a neural network, which processes bounding box prompt 311 and generates prompt embedding 315. In some embodiments, prompt encoder 127 converts user-specified or dataset-provided input bounding box prompt 311 into a numerical representation that encodes the spatial or semantic context of a target object in image 310. In some embodiments, prompt encoder 127 includes, without limitation, a multilayer perceptron (MLP), a transformer-based network, or a convolutional embedding module. For example, when bounding box prompt 311 includes a bounding box, prompt encoder 127 can learn positional and geometric relationships relative to image embedding 314. Although described herein primarily with respect to bounding box prompt 311 as a reference example, in some embodiments, the prompt can instead specify other information such as a point that is represented as a spatial coordinate feature map.

Mask decoder 128 is a machine learning model, such as a neural network, which processes image embedding 314 and prompt embedding 315 and generates the mask embedding. In some embodiments, mask decoder 128 combines visual features from image embedding 314 with spatial or semantic cues from prompt embedding 315 to predict the region of interest (e.g., amodal mask) in image 310. In some embodiments, mask decoder 128 includes, without limitation, a transformer-based decoder, a convolutional decoder, a multi-head attention module, and/or the like that fuses contextual information from image embedding 314 and prompt embedding 315. In some embodiments, mask decoder 128 applies upsampling layers, cross-attention, or feature concatenation operations to generate a dense spatial representation of the object mask.

In some embodiments, amodal mask prediction model 123 processes the mask embedding and generates predicted amodal mask 316 and prediction confidence 317. Predicted amodal mask 316 includes the estimated full shape of the target object in image 310, including both visible and occluded regions. In some embodiments, amodal mask prediction model 123 includes one or more activation functions that process the mask embedding and generate predicted amodal mask 316. For example, amodal mask prediction model 123 could include a sigmoid activation function to normalize the mask logits included in the mask embedding to values between 0 and 1, representing pixel-level probabilities of object occupancy. Prediction confidence 317 includes a measure of the certainty in predicted amodal mask 316, which can be generated by a separate IoU prediction head using an activation function, such as Rectified Linear Unit (ReLU), softmax, or sigmoid, depending on the implementation. In some embodiments, amodal mask prediction model 123 includes one or more activation functions that are applied at different layers to improve nonlinearity and feature expressiveness, such as Gaussian Error Linear Unit (GELU) or Leaky ReLU in intermediate layers and sigmoid in the final output layer.

Loss calculator 116 calculates loss 313 based on predicted amodal mask 316, prediction confidence 317, and ground truth amodal mask 312. In some embodiments, loss calculator 116 calculates loss 313 as a weighted combination of Dice loss, Focal loss, and L1 loss for IoU estimation, which in some examples can be represented as

$$ℒ = {ℒ}_{Dice} + {ℒ}_{Focal} + {λℒ}_{IoU} , \qquad ( Equation 2 )$$

where λ is a weighting factor (e.g., 0.05). In some embodiments, the Dice loss [symbol] measures the overlap between the predicted amodal mask 316 \hat{M} and ground truth amodal mask 312 M_{gt}, which in some examples can be described as

$${ℒ}_{Dice} = 1 - \frac{2 \vert \hat{M} ⋂ {M}_{gt} \vert}{\vert \hat{M} \vert + \vert {M}_{gt} \vert} . \qquad ( Equation 3 )$$

In some embodiments, the Focal loss [symbol] is used to focus the learning process on hard-to-classify pixels, which in some examples, can be described as

$${ℒ}_{Focal} = - {( 1 - {p}_{t} )}^{γ} log ( {p}_{t} ) , \qquad ( Equation 4 )$$

where pₜ represents the predicted probability for the target class and γ is a focusing parameter (e.g., γ=2). In some embodiments, the L1 loss for IoU estimation ensures that the predicted confidence 317 \hat{ρ} accurately reflects the true IoU between predicted amodal mask 316 and ground truth amodal masks 312. In some examples, the L1 loss can be described as

$${ℒ}_{IoU} = \vert \hat{ρ} - IoU ( \hat{M} , {M}_{gt} ) \vert . \qquad ( Equation 5 )$$

In some embodiments, model trainer 115 uses loss 313 to iteratively update the parameters of mask decoder 128. In some embodiments, model trainer 115 adjusts the parameters of mask decoder 128 using an optimization algorithm, such as adaptive moment estimation (Adam), stochastic gradient descent (SGD), and/or the like. The iterative process continues until one or more stopping criteria are met, such as convergence of loss 313, achievement of a target validation accuracy, or completion of a predefined number of training epochs. Once model trainer 115 trains amodal mask prediction model 123, model trainer 115 stores amodal mask prediction model 123 in data store 120 or elsewhere.

### Synthetic Amodal Training Data Generation Using Trained Amodal Mask Prediction Model and Modal Training Data

FIG. 4 is a more detailed illustration of synthetic amodal data generator 117, according to various embodiments. As shown, synthetic amodal data generator 117 includes, without limitation, trained amodal mask prediction model 123, an unoccluded object data generator 401, and an occluded object data generator 402. In operation, synthetic amodal data generator 117 uses the trained amodal mask prediction model 123 to process an image 410 included in modal training data 118 and a bounding box prompt 411 included in modal training data 118 and generates a predicted amodal mask 414. Unoccluded object data generator 401 processes predicted amodal mask 414, image 410, bounding box prompt 411, and a ground truth modal mask 413 included in modal training data 118 and generates an unoccluded object data 415. Occluded object data generator 402 processes unoccluded object data 415 and generates synthesized images and occluded object data 416. Synthetic amodal data generator 117 then stores unoccluded object data 415 and synthesized images and occluded object data 416 in synthetic amodal training data 125. Synthetic amodal data generator 117 continues generating synthetic amodal training data 125 until one or more stopping criteria are met.

Synthetic amodal data generator 117 uses trained amodal mask prediction model 123 to process modal training data 118 and generate synthetic amodal training data 125. Trained amodal mask prediction model 123 processes image 410 and bounding box prompt 411 and generates predicted amodal mask 414. Trained modal mask prediction model 123 includes image encoder 126, prompt encoder 127, and mask decoder 128. Image encoder 126 processes image 410 included in modal training data 118 and generates image embedding 314. Prompt encoder 127 processes bounding box prompt 411 included in modal training data 118 and generates prompt embedding 315. Mask decoder 128 processes image embedding 314 and prompt embedding 315 and generates a mask embedding. Trained amodal mask prediction model 123 processes the mask embedding and generates predicted amodal mask 414.

Unoccluded object data generator 401 is a module of synthetic amodal training data generator 117 that processes predicted amodal mask 414, image 410, bounding box prompt 411, and ground truth modal mask 413 included in modal training data 118 and generates unoccluded object data 415. In some embodiments, unoccluded object data generator 401 uses the trained amodal mask prediction model 123 to generate pseudo annotations for instances (e.g., a single, distinct occurrence of an object in image 410) included in modal training data 118, where, for each instance, predicted amodal mask 414 is compared with the corresponding visible mask annotation (e.g., ground truth modal mask 413). Instances for which predicted amodal mask 414 closely matches the visible mask annotation are identified as complete, unoccluded objects. The objects are then stored as unoccluded object data 415 (e.g., complete object pool). In some embodiments, unoccluded object data generator 401 performs one or more data filtering and quality control operations to ensure high-quality, realistic object representations. For example, in some embodiments, objects with minimal visible regions (e.g., visible parts occupying less than 10% of the full object area) or excessively large visible regions (e.g., objects occupying more than 90% of the image area) can be excluded. Unoccluded object data generator 401 also removes architectural or background elements (e.g., walls, floors, ceilings) that do not correspond to meaningful amodal instances. When modal training data 118 includes certain datasets with semantic annotations, such as COCOA-cls, unoccluded object data generator 401 filters out “stuff” classes to retain only well-defined object categories. The resulting unoccluded object data 415 includes image crops, masks, bounding boxes, and class annotations corresponding to fully visible, high-quality object instances.

Occluded object data generator 402 is a module of synthetic amodal training data generator 117 that processes unoccluded object data 415 and generates synthesized images and occluded object data 416. In some embodiments, occluded object data generator 402 synthesizes occlusion scenarios by compositing multiple unoccluded objects included in unoccluded object data 415 into the same image space, thereby creating realistic visual relationships between foreground and background objects. In some embodiments, occluded object data generator 402 uses geometric and spatial rules derived from real-world datasets to determine the relative placement, scale, and depth ordering of objects so that some objects partially cover others. In some embodiments, occluded object data generator 402 performs synthetic occlusion generation by pairing randomly selected complete objects from the complete object pool to create realistic occlusion patterns. To ensure that occlusions appear natural and physically consistent, occluded object data generator 402 normalizes the paired objects to similar scales while maintaining the respective aspect ratios. In some embodiments, occluded object data generator 402 applies occlusion threshold filtering to permit that occluded regions appear natural and physically plausible. For example, in some embodiments, occluded object data generator 402 can limit the percentage of an object that becomes occluded (e.g., between 10% and 60%) and avoid unrealistic overlaps, such as layering inconsistencies or floating intersections. Occluded object data generator 402 also ensures that the occluding and occluded objects belong to compatible semantic categories (e.g., a person standing behind a table, not behind the sky). In some embodiments, to improve dataset diversity and realism, occluded object data generator 402 randomizes lighting conditions, camera angles, and/or object textures, and applies augmentation techniques, such as translation, rotation, and/or scaling. The resulting synthesized images and occluded object data 416 includes newly composed images, along with corresponding amodal and modal masks, bounding boxes, and class annotation that describe both the visible and hidden portions of each object.

In some embodiments, synthetic amodal data generator 117 continues generating synthetic amodal training data 125 until one or more stopping criteria are met. The stopping criteria may include, without limitation, reaching a predefined number of generated samples, achieving a target diversity level across object categories and occlusion rates, or detecting convergence in the distribution of generated amodal masks. In some embodiments, synthetic amodal data generator 117 monitors the statistical balance between unoccluded object data 415 and synthesized images and occluded object data 416 to ensure that synthetic amodal training data 125 captures a realistic range of visibility and occlusion conditions. In some embodiments, synthetic amodal data generator 117 also evaluates the quality of newly generated samples using internal verification checks, such as mask consistency, object completeness, or occlusion plausibility scores. Once the stopping criteria are satisfied, synthetic amodal data generator 117 stores synthetic amodal training data 125 in data store 120 or elsewhere.

### Retraining the Trained Amodal Mask Prediction Model Using Synthetic Amodal Training Data

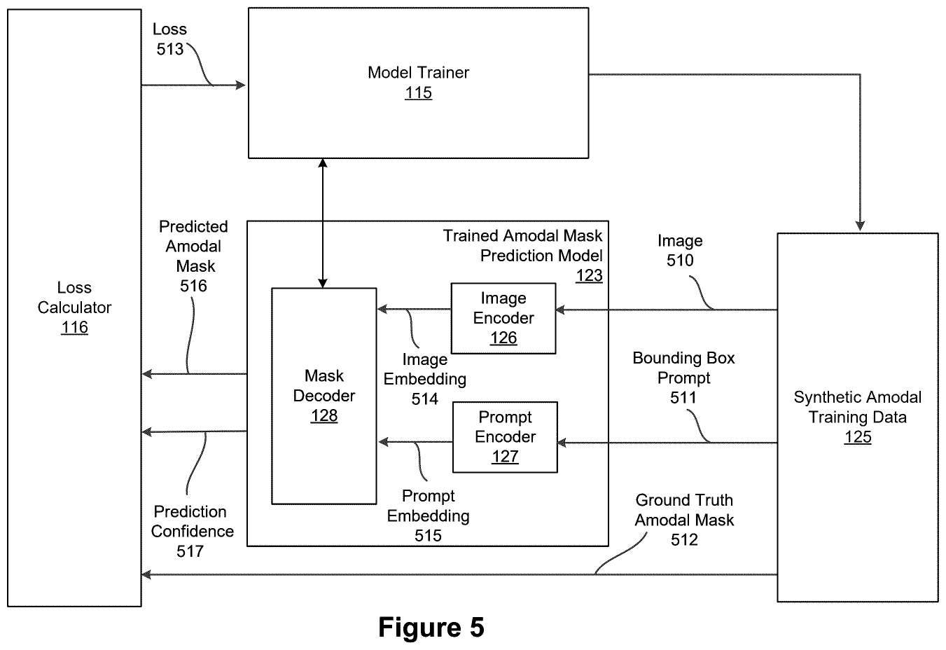

FIG. 5 illustrates how model trainer 115 retrains a trained amodal mask prediction model 123, according to various embodiments. As shown, trained amodal mask prediction model 123 includes, without limitation, image encoder 126, prompt encoder 127, and mask decoder 128. In operation, image encoder 126 processes image 510 included in synthetic amodal training data 125 and generates an image embedding 514. Prompt encoder 127 processes a bounding box prompt 511 and generates a prompt embedding 515. Mask decoder 128 processes image embedding 514 and prompt embedding 515 and generates a mask embedding. Trained amodal mask prediction model 123 processes the mask embedding and generates a predicted amodal mask 516 and a prediction confidence 517. Loss calculator 116 calculates a loss 513 based on predicted amodal mask 516 and prediction confidence 517. Model trainer 115 uses loss 513 to update the parameters of mask decoder 128 iteratively until one or more stopping criteria are met.

Image encoder 126 processes image 510 and generates image embedding 514. In some embodiments, image encoder 126 includes, without limitation, a CNN, a ViT, and/or the like. When implemented as a convolutional neural network, image encoder 126 extracts hierarchical visual features, such as edges, shapes, and object parts using convolutional and pooling layers. When implemented as a vision transformer, image encoder 126 divides image 510 into patches and uses self-attention mechanisms to model relationships between distant regions of image 510.

Prompt encoder 127 processes bounding box prompt 511 and generates prompt embedding 515. In some embodiments, prompt encoder 127 converts user-specified or dataset-provided input bounding box prompt 511 into a numerical representation that encodes the spatial or semantic context of a target object in image 510. In some embodiments, prompt encoder 127 includes, without limitation, an MLP, a transformer-based network, or a convolutional embedding module. For example, when bounding box prompt 511 includes a bounding box, prompt encoder 127 can learn positional and geometric relationships relative to image embedding 514.

Mask decoder 128 processes image embedding 514 and prompt embedding 515 and generates the mask embedding. In some embodiments, mask decoder 128 combines visual features from image embedding 514 with spatial or semantic cues from prompt embedding 515 to predict the region of interest (e.g., amodal mask) in image 510. In some embodiments, mask decoder 128 includes, without limitation, a transformer-based decoder, a convolutional decoder, a multi-head attention module, and/or the like, that fuses contextual information from image embedding 514 and prompt embedding 515. In some embodiments, mask decoder 128 applies upsampling layers, cross-attention, or feature concatenation operations to generate a dense spatial representation of the object mask.

In some embodiments, amodal mask prediction model 123 processes the mask embedding and generates predicted amodal mask 516 and prediction confidence 517. Predicted amodal mask 516 includes the estimated full shape of the target object in image 510, including both visible and occluded regions. In some embodiments, amodal mask prediction model 123 includes one or more activation functions that process the mask embedding and generate predicted amodal mask 516. For example, amodal mask prediction model 123 can include a sigmoid activation function to normalize the mask logits included in the mask embedding to values between 0 and 1, representing pixel-level probabilities of object occupancy. Prediction confidence 517 includes a measure of the certainty in predicted amodal mask 516, which can be generated by a separate IoU prediction head using an activation function, such as ReLU, softmax, or sigmoid, depending on the implementation. In some embodiments, amodal mask prediction model 123 includes one or more activation functions that are applied at different layers to improve nonlinearity and feature expressiveness, such as GELU or Leaky ReLU in intermediate layers and sigmoid in the final output layer.

Loss calculator 116 calculates loss 513 based on predicted amodal mask 516, prediction confidence 517, and ground truth amodal mask 512. In some embodiments, loss calculator 116 calculates loss 513 as a weighted combination of Dice loss, Focal loss, and L1 loss for IoU estimation, which in some examples can be represented as given in Equation 2. In some embodiments, the Dice loss [symbol] measures the overlap between predicted amodal mask 516 \hat{M} and ground truth amodal mask 512 M_{gt}, which in some examples can be described as given in Equation 3. In some embodiments, the Focal loss [symbol] is used to focus the learning process on hard-to-classify pixels. In some examples, the Focal loss can be described as given in Equation 4. In some embodiments, the L1 loss for IoU estimation ensures that the predicted confidence 517 \hat{ρ} accurately reflects the true IoU between predicted amodal mask 516 and ground truth amodal masks 512, which in some examples can be calculated as given in Equation 5.

In some embodiments, model trainer 115 uses loss 513 to iteratively update the parameters of mask decoder 128. In some embodiments, model trainer 115 adjusts the parameters of mask decoder 128 using an optimization algorithm, such as Adam, SGD, and/or the like. In some embodiments, during the retraining, model trainer 115 uses a balanced mixture of synthesized images and occluded object data 416 and unoccluded object data 415 included in synthetic amodal training data 125, where training samples are drawn with approximately equal probability (e.g., 50% occluded and 50% unoccluded). The balanced sampling ensures that the retrained amodal mask prediction model learns to accurately infer both visible and hidden object regions. The iterative retraining process continues until one or more stopping criteria are met, such as convergence of loss 513, achievement of a target validation accuracy, or completion of a predefined number of training epochs. Once model trainer 115 retrains trained amodal mask prediction model 123, model trainer 115 stores retrained amodal mask prediction model in data store 120 or elsewhere.

### Amodal Mask Generation Using Retrained Amodal Mask Prediction Model

FIG. 6 is a more detailed illustration of amodal mask generation application 146, according to various embodiments. As shown, amodal mask generation application 146 includes a prompt detector 610 and retrained amodal mask prediction model 606. In operation, prompt detector 610 processes input image 601 and generates detected bounding box prompt 604. Optionally, amodal mask generation application 146 processes a user prompt 602 and generates a bounding box prompt. The retained amodal mask prediction model 606 processes input image 601 and at least one of detected bounding box prompt 604 or the bounding box prompt and generates predicted amodal mask 603.

Prompt detector 610 is a machine learning model, such as a neural network, which processes input image 601 and generates detected bounding box prompt 604. In some embodiments, prompt detector 610 includes an object detection network configured to identify regions of interest corresponding to potential object instances included in input image 601. Detected bounding box prompts 604 define spatial coordinates (e.g., x, y, width, height) enclosing target objects. In some examples, prompt detector 610 can be integrated with various types of object detectors, including amodal detectors (e.g., Amodal Instance Segmentation Transformer) and conventional modal detectors (e.g., Real-Time Multi-task Detector). When integrated with a modal detector, prompt detector 610 generates visible bounding boxes. When integrated with an amodal detector, prompt detector 610 generates bounding boxes that already approximate the full object extent. In some embodiments, prompt detector 610 generates a plurality of detected bounding box prompts 604 per input image 601.

In some embodiments, amodal mask generation application 146 optionally processes a user prompt 602 and generates a bounding box prompt. User prompt 602 includes, without limitation, a point, click, brush stroke, text description, or region selection provided by a user to indicate an area or object of interest within input image 601. Based on user prompt 602, amodal mask generation application 146 determines spatial coordinates that define the bounding box prompt enclosing the indicated object or region. In some embodiments, amodal mask generation application 146 uses heuristic or learned rules to expand or refine the bounding box boundaries based on image content or prior detections. For example, when the user selects a point on an object in input image 601, amodal mask generation application 146 could use surrounding gradients, edge cues, or semantic feature maps to infer an appropriate bounding box size and position. In some examples, when user prompt 602 includes a text-based prompt (e.g., “segment the car in the center”), amodal mask generation application 146 can use a multimodal encoder to locate the corresponding object in input image 601 and generate the bounding box prompt accordingly.

In some embodiments, retrained amodal mask prediction model 606 processes input image 601 and at least one of detected bounding box prompt 604 or the bounding box prompt and generates predicted amodal mask 603. In some embodiments, image encoder 126 processes input image 601 and generates image embedding 514. Prompt encoder 127 processes at least one of the bounding box prompt or detected bounding box prompt 604 and generates prompt embedding 515. Mask decoder 128 processes image embedding 514 and prompt embedding 515 and generates a mask embedding. Retrained amodal mask prediction model 606 processes the mask embedding and generates predicted amodal mask 603.

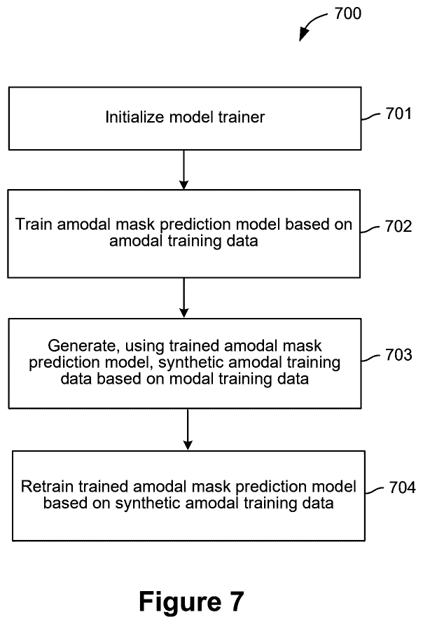

FIG. 7 is a flow diagram of method steps for training amodal mask prediction model 123, generating synthetic amodal training data 125, and retraining trained amodal mask prediction model 123, according to various embodiments. Although the method steps are described in conjunction with the systems of FIGS. 1-6, persons skilled in the art will understand that any system configured to perform the method steps in any order falls within the scope of the present disclosure.

As shown, a method 700 begins with step 701, where model trainer 115 is initialized. In some embodiments, model trainer 115 is initialized by setting one or more training parameters, such as initializing Adam optimizer with a learning rate of 1×10⁻⁴, initializing γ=2 in Equation 4 and λ=0.05 in Equation 2, and a balanced sampling strategy that selects modal and amodal bounding box prompts with equal probability. In some examples, model trainer 115 configures a batch size of 32 and iterates training for a predefined number of steps (e.g., 1,440 to 22,500 iterations depending on the dataset) without a learning rate scheduler.

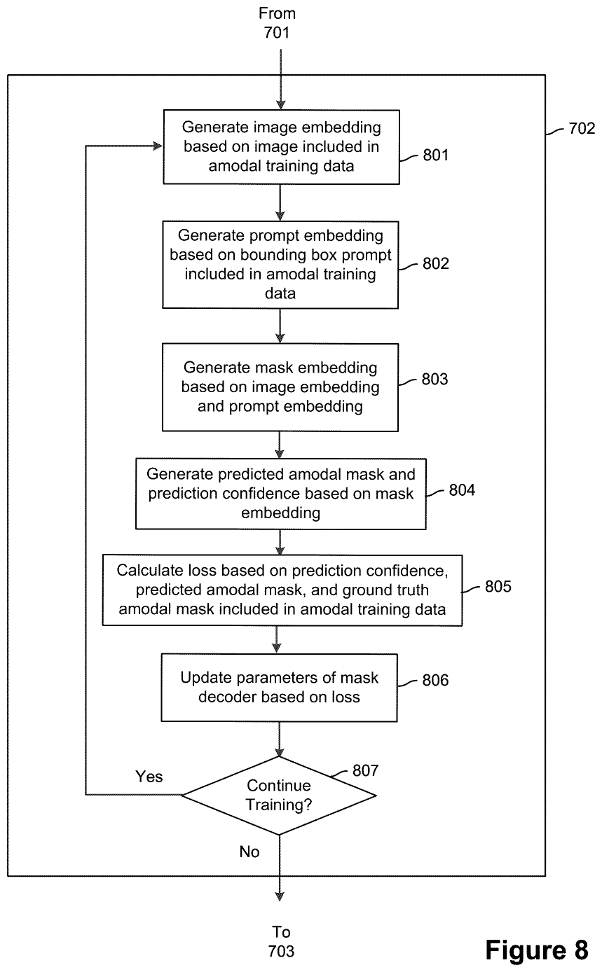

At step 702, model trainer 115 trains amodal mask prediction model 123 based on amodal training data 124. In some embodiments, amodal mask prediction model 123 can be initialized to a pre-trained segmentation model that is able to perform modal mask prediction, and the pre-trained segmentation model is further trained to perform the amodal mask prediction task. In some embodiments, image encoder 126 processes image 310 included in amodal training data 124 and generates image embedding 314. Prompt encoder 127 processes bounding box prompt 311 included in amodal training data 124 and generates prompt embedding 315. Mask decoder 128 processes image embedding 314 and prompt embedding 315 and generates a mask embedding. Amodal mask prediction model 123 processes the mask embedding and generates predicted amodal mask 316 and prediction confidence 317. Loss calculator 116 calculates loss 313 based on predicted amodal mask 316, prediction confidence 317, and ground truth amodal mask 312 included in amodal training data 124. Model trainer 115 uses loss 313 to update the parameters of mask decoder 128 iteratively until one or more stopping criteria are met. Once trained, model trainer 115 stores trained amodal mask prediction model 123 in datastore 120 or elsewhere. Step 702 is described in greater detail in conjunction with FIG. 8.

At step 703, synthetic amodal training data generator 117 generates, using trained amodal mask prediction model 123, synthetic amodal training data 125 based on modal training data 124. In some embodiments, synthetic amodal data generator 117 uses the trained amodal mask prediction model 123 to process image 410 included in modal training data 118 and bounding box prompt 411 included in modal training data 118 and generates predicted amodal mask 414. Unoccluded object data generator 401 processes predicted amodal mask 414, image 410, bounding box prompt 411, and ground truth modal mask 413 included in modal training data 118 and generates unoccluded object data 415. Occluded object data generator 402 processes unoccluded object data 415 and generates synthesized images and occluded object data 416. Synthetic amodal data generator 117 then stores unoccluded object data 415 and synthesized images and occluded object data 416 in synthetic amodal training data 125. Synthetic amodal data generator 117 continues generating synthetic amodal training data 125 until one or more stopping criteria are met. Once generated, synthetic amodal training data generator 117 stores synthetic amodal training data 125 in datastore 120 or elsewhere. Step 703 is described in greater detail in conjunction with FIG. 9.

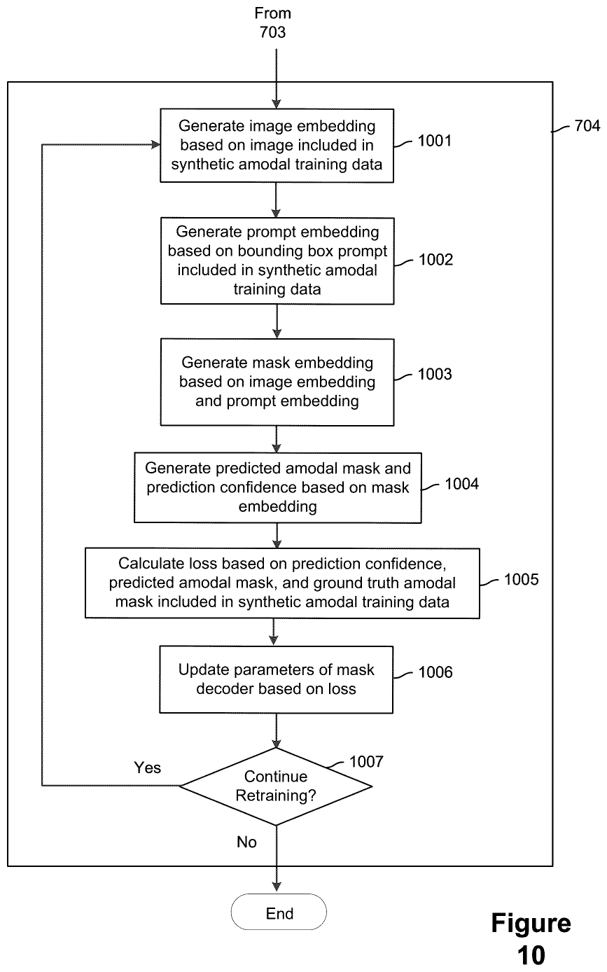

At step 704, model trainer 115 retrains trained amodal mask prediction model 123 based on synthetic amodal training data 125. In some embodiments, image encoder 126 processes image 510 included in synthetic amodal training data 125 and generates image embedding 514. Prompt encoder 127 processes bounding box prompt 511 and generates prompt embedding 515. Mask decoder 128 processes image embedding 514 and prompt embedding 515 and generates a mask embedding. Trained amodal mask prediction model 123 processes the mask embedding and generates predicted amodal mask 516 and prediction confidence 517. Loss calculator 116 calculates loss 513 based on predicted amodal mask 516 and prediction confidence 517. Model trainer 115 uses loss 513 to update the parameters of mask decoder 128 iteratively until one or more stopping criteria are met. Once retrained, model trainer 115 stores the retrained amodal mask prediction model 606 in datastore 120 or elsewhere. Step 704 is described in greater detail in conjunction with FIG. 10.

FIG. 8 is a flow diagram of method steps for training amodal mask prediction model 123, according to various embodiments. Although the method steps are described in conjunction with the systems of FIGS. 1-6, persons skilled in the art will understand that any system configured to perform the method steps in any order falls within the scope of the present disclosure.

As shown, step 702 begins with step 801, where image encoder 126 generates image embedding 314 based on image 310 included in amodal training data 124. In some embodiments, image encoder 126 includes, without limitation, a CNN, a ViT, and/or the like. When implemented as a convolutional neural network, image encoder 126 extracts hierarchical visual features, such as edges, shapes, and object parts using convolutional and pooling layers. When implemented as a vision transformer, image encoder 126 divides image 310 into patches and uses self-attention mechanisms to model relationships between distant regions of image 310, improving scene-level understanding.

At step 802, prompt encoder 127 generates prompt embedding 315 based on bounding box prompt 311 included in amodal training data 124. In some embodiments, prompt encoder 127 converts user-specified or dataset-provided input bounding box prompt 311 into a numerical representation that encodes the spatial or semantic context of a target object in image 310. When bounding box prompt 311 includes a bounding box, prompt encoder 127 can learn positional and geometric relationships relative to image embedding 314, while a point bounding box prompt can be represented as a spatial coordinate feature map.

At step 803, mask decoder 128 generates mask embedding based on image embedding 314 and prompt embedding 315. In some embodiments, mask decoder 128 combines visual features from image embedding 314 with spatial or semantic cues from prompt embedding 315 to predict the region of interest (e.g., amodal mask) in image 310. In some embodiments, mask decoder 128 includes, without limitation, a transformer-based decoder, a convolutional decoder, a multi-head attention module, and/or the like, that fuses contextual information from image embedding 314 and prompt embedding 315. In some embodiments, mask decoder 128 applies upsampling layers, cross-attention, or feature concatenation operations to generate a dense spatial representation of the object mask.

At step 804, amodal mask prediction model 123 generates predicted amodal mask 316 and prediction confidence 317 based on the mask embedding. In some embodiments, amodal mask prediction model 123 includes one or more activation functions that process the mask embedding and generate predicted amodal mask 316. For example, amodal mask prediction model 123 can include a sigmoid activation function to normalize the mask logits included in the mask embedding to values between 0 and 1. Prediction confidence 317 can be generated by a separate IoU prediction head using an activation function, such as ReLU, softmax, or sigmoid, depending on the implementation. In some embodiments, amodal mask prediction model 123 includes one or more activation functions that are applied at different layers to improve nonlinearity and feature expressiveness, such as GELU or Leaky ReLU in intermediate layers and sigmoid in the final output layer.

At step 805, loss calculator 116 calculates loss 313 based on prediction confidence 317, predicted amodal mask 316, and ground truth amodal mask 312 included in amodal training data 124. In some embodiments, loss calculator 116 calculates loss 313 as a weighted combination of Dice loss, Focal loss, and L1 loss for IoU estimation, which in some examples can be represented as given in Equation 2. In some embodiments, the Dice loss [symbol] measures the overlap between the predicted amodal mask 316 \hat{M} and ground truth amodal mask 312 M_{gt}, which in some examples can be described as given in Equation 3. In some embodiments, the Focal loss [symbol] is used to focus the learning process on hard-to-classify pixels, which in some examples, can be described as given in Equation 4. In some embodiments, the L1 loss for IoU estimation ensures that the predicted confidence 317 \hat{ρ} accurately reflects the true IoU between predicted amodal mask 316 and ground truth amodal masks 312. In some examples, the L1 loss can be described as given in Equation 5.

At step 806, model trainer 115 updates parameters of mask decoder 128 based on loss 313. In some embodiments, model trainer 115 adjusts the parameters of mask decoder 128 using an optimization algorithm, such as Adam, SGD, and/or the like.

At step 807, model trainer 115 determines whether to continue training. In some embodiments, the iterative process continues until one or more stopping criteria are met, such as convergence of loss 313, achievement of a target validation accuracy, or completion of a predefined number of training epochs. When model trainer 115 determines to continue training, step 702 returns to step 801. When model trainer 115 determines not to continue training, step 702 proceeds to step 703.

FIG. 9 is a flow diagram of method steps for generating synthetic amodal training data 117, according to various embodiments. Although the method steps are described in conjunction with the systems of FIGS. 1-6, persons skilled in the art will understand that any system configured to perform the method steps in any order falls within the scope of the present disclosure.

As shown, step 703 begins with step 901, where synthetic amodal training data generator 117 generates, using trained amodal mask prediction model 123, predicted amodal mask 414 based on image 410 and bounding box prompt 411 included in modal training data 118. In some embodiments, image encoder 126 processes image 410 included in modal training data 118 and generates image embedding 314. Prompt encoder 127 processes bounding box prompt 411 included in modal training data 118 and generates prompt embedding 315. Mask decoder 128 processes image embedding 314 and prompt embedding 315 and generates a mask embedding. Trained amodal mask prediction model 123 processes the mask embedding and generates predicted amodal mask 414.

At step 902, unoccluded object data generator 401 generates unoccluded object data based on predicted amodal mask 414, image 410, bounding box prompt 411, and ground truth modal mask 413 included in modal training data 118. In some embodiments, unoccluded object data generator 401 uses the trained amodal mask prediction model 123 to generate pseudo annotations for instances (e.g., a single, distinct occurrence of an object in image 410) included in modal training data 118, where, for each instance, predicted amodal mask 414 is compared with the corresponding visible mask annotation (e.g., ground truth modal mask 413). Instances for which predicted amodal mask 414 closely matches the visible mask annotation are identified as complete, unoccluded objects. The objects are then stored as unoccluded object data 415 (e.g., complete object pool). In some embodiments, unoccluded object data generator 401 performs one or more data filtering and quality control operations to ensure high-quality, realistic object representations. Unoccluded object data generator 401 also removes architectural or background elements (e.g., walls, floors, ceilings) that do not correspond to meaningful amodal instances. When modal training data 118 includes certain datasets with semantic annotations, such as COCOA-cls, unoccluded object data generator 401 filters out “stuff” classes to retain only well-defined object categories.

At step 903, occluded object data generator 402 generates synthesized images and occluded object data 416 based on unoccluded object data 415. In some embodiments, occluded object data generator 402 synthesizes occlusion scenarios by compositing multiple unoccluded objects included in unoccluded object data 415 into the same image space, thereby creating realistic visual relationships between foreground and background objects. In some embodiments, occluded object data generator 402 uses geometric and spatial rules derived from real-world datasets to determine the relative placement, scale, and depth ordering of objects so that some objects partially cover others. In some embodiments, occluded object data generator 402 performs synthetic occlusion generation by pairing randomly selected complete objects from the complete object pool to create realistic occlusion patterns. To ensure that occlusions appear natural and physically consistent, occluded object data generator 402 normalizes the paired objects to similar scales while maintaining the respective aspect ratios. In some embodiments, occluded object data generator 402 applies occlusion threshold filtering to permit that occluded regions appear natural and physically plausible. For example, in some embodiments, occluded object data generator 402 can limit the percentage of an object that becomes occluded (e.g., between 10% and 60%) and avoid unrealistic overlaps, such as layering inconsistencies or floating intersections. Occluded object data generator 402 also ensures that the occluding and occluded objects belong to compatible semantic categories. In some embodiments, to improve dataset diversity and realism, occluded object data generator 402 randomizes lighting conditions, camera angles, and/or object textures, and applies augmentation techniques, such as translation, rotation, and/or scaling.

At step 903, synthetic amodal data generator 117 stores synthesized images, occluded object data 416 and unoccluded object data 415 in synthetic amodal training data 125.

At step 904, synthetic amodal data generator 117 determines whether to continue generating. In some embodiments, synthetic amodal data generator 117 continues generating synthetic amodal training data 125 until one or more stopping criteria are met. The stopping criteria can include, without limitation, reaching a predefined number of generated samples, achieving a target diversity level across object categories and occlusion rates, or detecting convergence in the distribution of generated amodal masks. In some embodiments, synthetic amodal data generator 117 monitors the statistical balance between unoccluded object data 415 and synthesized images and occluded object data 416 to ensure that synthetic amodal training data 125 captures a realistic range of visibility and occlusion conditions. In some embodiments, synthetic amodal data generator 117 also evaluates the quality of newly generated samples using internal verification checks, such as mask consistency, object completeness, or occlusion plausibility scores. When synthetic amodal data generator 117 determines to continue generating, step 703 returns to step 901. When synthetic amodal data generator 117 determines not to continue generating, step 703 proceeds to step 704.

FIG. 10 is a flow diagram of method steps for retraining trained amodal mask prediction model 123, according to various embodiments. Although the method steps are described in conjunction with the systems of FIGS. 1-6, persons skilled in the art will understand that any system configured to perform the method steps in any order falls within the scope of the present disclosure.

As shown, step 704 begins with step 1001, where image encoder 126 generates image embedding 514 based on image 510 included in synthetic amodal training data 125. In some embodiments, image encoder 126 includes, without limitation, a CNN, a ViT, and/or the like. When implemented as a convolutional neural network, image encoder 126 extracts hierarchical visual features, such as edges, shapes, and object parts using convolutional and pooling layers. When implemented as a vision transformer, image encoder 126 divides image 510 into patches and uses self-attention mechanisms to model relationships between distant regions of image 510.

At step 1002, prompt encoder 127 generates prompt embedding 515 based on bounding box prompt 511 included in synthetic amodal training data 125. In some embodiments, prompt encoder 127 converts user-specified or dataset-provided input bounding box prompt 511 into a numerical representation that encodes the spatial or semantic context of a target object in image 510. In some embodiments, prompt encoder 127 includes, without limitation, an MLP, a transformer-based network, or a convolutional embedding module. For example, when bounding box prompt 511 includes a bounding box, prompt encoder 127 can learn positional and geometric relationships relative to image embedding 514.

At step 1003, mask decoder 128 generates mask embedding based on image embedding 514 and prompt embedding 515. In some embodiments, mask decoder 128 combines visual features from image embedding 514 with spatial or semantic cues from prompt embedding 515 to predict the region of interest (e.g., amodal mask) in image 510. In some embodiments, mask decoder 128 includes, without limitation, a transformer-based decoder, a convolutional decoder, a multi-head attention module, and/or the like, that fuses contextual information from image embedding 514 and prompt embedding 515. In some embodiments, mask decoder 128 applies upsampling layers, cross-attention, or feature concatenation operations to generate a dense spatial representation of the object mask.

At step 1004, amodal mask prediction model 123 generates predicted amodal mask 516 and prediction confidence 517 based on mask embedding. In some embodiments, amodal mask prediction model 123 includes one or more activation functions that process the mask embedding and generate predicted amodal mask 516. For example, amodal mask prediction model 123 could include a sigmoid activation function to normalize the mask logits included in the mask embedding to values between 0 and 1. Prediction confidence 517 can be generated by a separate IoU prediction head using an activation function, such as ReLU, softmax, or sigmoid, depending on the implementation. In some embodiments, amodal mask prediction model 123 includes one or more activation functions that are applied at different layers to improve nonlinearity and feature expressiveness, such as GELU or Leaky ReLU in intermediate layers and sigmoid in the final output layer.

At step 1005, loss calculator 116 calculates loss 513 based on prediction confidence 517, predicted amodal mask 516, and ground truth amodal mask 512 included in synthetic amodal training data 125. In some embodiments, loss calculator 116 calculates loss 513 as a weighted combination of Dice loss, Focal loss, and L1 loss for IoU estimation, which in some examples can be represented as given in Equation 2. In some embodiments, the Dice loss [symbol] measures the overlap between predicted amodal mask 516 \hat{M} and ground truth amodal mask 512 M_{gt}, which in some examples can be described as given in Equation 3. In some embodiments, the Focal loss [symbol] is used to focus the learning process on hard-to-classify pixels. In some examples, the Focal loss can be described as given in Equation 4. In some embodiments, the L1 loss for IoU estimation ensures that the predicted confidence 517 \hat{ρ} accurately reflects the true IoU between predicted amodal mask 516 and ground truth amodal masks 512, which in some examples can be calculated as given in Equation 5.

At step 1006, model trainer 115 updates parameters of mask decoder 128 based on loss 513. In some embodiments, model trainer 115 adjusts the parameters of mask decoder 128 using an optimization algorithm, such as Adam, SGD, and/or the like. In some embodiments, during the retraining, model trainer 115 uses a balanced mixture of synthesized images and occluded object data 416 and unoccluded object data 415 included in synthetic amodal training data 125, where training samples are drawn with approximately equal probability (e.g., 50% occluded and 50% unoccluded).

At step 1007, model trainer 115 determines whether to continue retraining. In some embodiments, the iterative retraining process continues until one or more stopping criteria are met, such as convergence of loss 513, achievement of a target validation accuracy, or completion of a predefined number of training epochs. When model trainer 115 determines to continue retraining, step 704 returns to step 1001. When model trainer 115 determines not to continue retraining, the method 700 terminates.

FIG. 11 is the flow diagram of method steps for generating predicted amodal mask 603, according to various embodiments. Although the method steps are described in conjunction with the systems of FIGS. 1-6, persons skilled in the art will understand that any system configured to perform the method steps in any order falls within the scope of the present disclosure.

As shown, a method 1100 begins with step 1101, where prompt detector 610 receives an input image 601.

At step 1102, prompt detector 610 generates detected bounding box prompt 604 based on input image 601. In some embodiments, prompt detector 610 includes an object detection network configured to identify regions of interest corresponding to potential object instances included in input image 601. In some examples, prompt detector 610 can be integrated with various types of object detectors, including amodal detectors (e.g., Amodal Instance Segmentation Transformer) and conventional modal detectors (e.g., Real-Time Multi-task Detector). When integrated with a modal detector, prompt detector 610 generates visible bounding boxes. When integrated with an amodal detector, prompt detector 610 generates bounding boxes that already approximate the full object extent. In some embodiments, prompt detector 610 generates a plurality of detected bounding box prompts 604 per input image 601.

At step 1103, amodal mask generation application 146 optionally receives user prompt 602. User prompt 602 includes, without limitation, a point, click, brush stroke, text description, or region selection provided by a user to indicate an area or object of interest within input image 601.

At step 1104, amodal mask generation application 146 optionally generates bounding box prompt based on user prompt 602. In some embodiments, based on user prompt 602, amodal mask generation application 146 determines spatial coordinates that define the bounding box prompt enclosing the indicated object or region. In some embodiments, amodal mask generation application 146 uses heuristic or learned rules to expand or refine the bounding box boundaries based on image content or prior detections. For example, when the user selects a point on an object in input image 601, amodal mask generation application 146 could use surrounding gradients, edge cues, or semantic feature maps to infer an appropriate bounding box size and position. In some examples, when user prompt 602 includes a text-based prompt, amodal mask generation application 146 can use a multimodal encoder to locate the corresponding object in input image 601 and generate the bounding box prompt accordingly.

At step 1105, retrained amodal mask prediction model 606 generates predicted amodal mask 603 based on at least one of detected bounding box prompt 604 or the bounding box prompt generated based on the user prompt. In some embodiments, image encoder 126 processes input image 601 and generates image embedding 514. Prompt encoder 127 processes at least one of the bounding box prompt or detected bounding box prompt 604 and generates prompt embedding 515. Mask decoder 128 processes image embedding 514 and prompt embedding 515 and generates a mask embedding. Retrained amodal mask prediction model 606 processes the mask embedding and generates predicted amodal mask 603.

In sum, techniques are disclosed for amodal mask prediction and synthetic amodal data generation. In some embodiments, an amodal mask prediction model is a machine learning model, such as a neural network, that processes an image and a bounding box prompt and generates a predicted amodal mask and a prediction confidence. The amodal mask prediction model includes an image encoder, a prompt encoder, and a mask decoder. The image encoder is another machine learning model, such as a neural network, that processes the image and generates an image embedding. The prompt encoder is yet another machine learning model, such as a neural network, that processes the bounding box prompt and generates a prompt embedding. The mask decoder is still another machine learning model that processes the image embedding and the prompt embedding and generates a mask embedding. In some embodiments, a model trainer trains the amodal mask prediction model based on amodal training data. During training, the image encoder processes an image included in the amodal training data and generates the image embedding. The prompt encoder processes a prompt included in the amodal training data and generates the prompt embedding. The mask decoder processes the image embedding and the prompt embedding and generates the mask embedding. The amodal mask prediction model processes the mask embedding and generates the predicted amodal mask and the prediction confidence. A loss calculator calculates a loss based on the predicted amodal mask, the prediction confidence, and a ground truth amodal mask included in the amodal training data. The model trainer uses the loss to update the parameters of the mask decoder iteratively until one or more stopping criteria are met.

In some embodiments, a synthetic amodal data generator uses a trained amodal mask prediction model to generate synthetic amodal training data based on modal training data. The synthetic amodal data generator includes an unoccluded object data generator and an occluded object data generator. During the data generation, the synthetic amodal data generator uses the trained amodal mask prediction model to process an image included in the modal training data and a prompt included in the modal training data and generates the predicted amodal mask. The unoccluded object data generator processes the predicted amodal mask, the image, the prompt, and a ground truth modal mask included in the modal training data and generates unoccluded object data that includes an image crop, a full amodal mask, and a visible modal mask. The occluded object data generator processes the unoccluded object data and generates synthesized images and occluded object data by sampling one or more objects from the unoccluded object data and creating synthetic occlusions by compositing pairs of the objects to simulate real-world overlap conditions at varying occlusion ratios. The synthetic amodal data generator then stores the unoccluded object data and the synthesized images and occluded object data in synthetic amodal training data. The synthetic amodal data generator continues generating synthetic amodal training data until one or more stopping criteria are met.

In some embodiments, the model trainer retrains the trained amodal mask prediction model based on the synthetic amodal training data. During the retraining, the image encoder processes an image included in the synthetic amodal training data and generates the image embedding. The prompt encoder processes a bounding box prompt included in the synthetic amodal training data and generates the prompt embedding. The mask decoder processes the image embedding and the prompt embedding and generates the mask embedding. The trained mask prediction model processes the mask embedding and generates the predicted amodal mask and a prediction confidence. The loss calculator calculates a loss based on the predicted amodal mask, the prediction confidence, and a ground truth amodal mask included in the synthetic amodal training data. The model trainer uses the loss to update the parameters of the trained mask decoder iteratively until one or more stopping criteria are met. Once retrained, the trained amodal mask prediction model can be deployed using an amodal mask generation application to process an input image and optionally a user prompt and generate the predicted amodal mask.

At least one technical advantage of the disclosed techniques relative to the prior art is that the disclosed techniques improve the generation of synthetic amodal training data by generating synthetic images that more accurately capture realistic occlusion relationships among objects. Unlike conventional synthetic datasets that lack reliable mechanisms for verifying object completeness, the disclosed techniques generate synthesized images with built-in consistency checks, ensuring that the synthesized images reflect plausible real-world visibility and occlusion conditions. In addition, the disclosed techniques decouple the amodal mask prediction component from the modal detection component, allowing the amodal mask decoder to leverage pretrained modal detectors without redundant joint training. As a result, the disclosed techniques can automatically generate large quantities of high-quality synthetic amodal training data, which can in turn be used to train machine learning models that correctly predict amodal masks for input images. These technical advantages provide one or more technological improvements over prior art approaches.

The following clauses describe aspects of the various embodiments.

1. In some embodiments, a computer-implemented method for training a machine learning model for image segmentation includes generating, based on one or more first images and one or more first bounding box prompts, and using a first trained machine learning model, a first predicted amodal mask, generating, based on the first predicted amodal mask, the one or more first images, the one or more first bounding box prompts, and one or more ground truth modal masks, unoccluded object data, generating, based on the unoccluded object data, one or more synthetic images and occluded object data, and performing, based on the one or more synthetic images and the occluded object data, one or more operations to train a second machine learning model to generate a second trained machine learning model, where the second trained machine learning model processes a second image and a second bounding box prompt to generate a second predicted amodal mask.

2. The computer-implemented method of clause 1, where generating the unoccluded object data includes comparing the first predicted amodal mask with a first ground truth modal mask included in the one or more ground truth modal masks to identify an unoccluded object.

3. The computer-implemented method of clauses 1 or 2, where generating the unoccluded object data includes excluding at least one of a first object with one or more visible parts occupying less than a first percentage of an area associated with a third image included in the one or more first images, or a second object with one or more visible parts occupying more than a second percentage of the area associated with the third image included in the one or more first images.

4. The computer-implemented method of any of clauses 1-3, where generating the unoccluded object data includes filtering out a class of one or more object categories included in the one or more first images.

5. The computer-implemented method of any of clauses 1-4, where generating the one or more synthetic images and the occluded object data includes compositing a foreground object included in the plurality of unoccluded objects and a background object included in the plurality of unoccluded objects to generate at least one synthetic image included in the one or more synthetic images.

6. The computer-implemented method of any of clauses 1-5, where generating the one or more synthetic images and the occluded object data includes randomly selecting a first object and a second object from the unoccluded object data, and pairing the first object and the second object to generate an occlusion pattern within at least one synthetic image included in the one or more synthetic images.

7. The computer-implemented method of any of clauses 1-6, where generating the one or more synthetic images and the occluded object data includes limiting, within at least one synthetic image included in the one or more synthetic images, a percentage of a first object included in the unoccluded object data that is occluded by a second object included in the unoccluded object data.

8. The computer-implemented method of any of clauses 1-7, where generating the one or more synthetic images and the occluded object data includes determining, based on one or more geometric rules and one or more spatial rules, at least one of a relative placement, a scale, or a depth ordering associated with one or more objects within at least one synthetic image included in the one or more synthetic images.

9. The computer-implemented method of any of clauses 1-8, where generating the one or more synthetic images and the occluded object data includes normalizing a foreground object and a background object included in the unoccluded object data to a scale, and maintaining a first aspect ratio of the foreground object and a second aspect ratio of the background object within at least one synthetic image included in the one or more synthetic images.

10. The computer-implemented method of any of clauses 1-9, where generating the one or more synthetic images and the occluded object data includes randomizing at least one of one or more lighting conditions, one or more camera angles, or one or more object textures within at least one synthetic image included in the one or more synthetic images.

11. In some embodiments, one or more non-transitory computer-readable media store instructions that, when executed by one or more processors, cause the one or more processors to perform the steps of generating, based on one or more first images and one or more first bounding box prompts, and using a first trained machine learning model, a first predicted amodal mask, generating, based on the first predicted amodal mask, the one or more first images, the one or more first bounding box prompts, and one or more ground truth modal masks, unoccluded object data, generating, based on the unoccluded object data, one or more synthetic images and occluded object data, and performing, based on the one or more synthetic images and the occluded object data, one or more operations to train a second machine learning model to generate a second trained machine learning model, where the second trained machine learning model processes a second image and a second bounding box prompt to generate a second predicted amodal mask.

12. The one or more non-transitory computer-readable media of clause 11, where generating the unoccluded object data includes comparing the first predicted amodal mask with a first ground truth modal mask included in the one or more ground truth modal masks to identify an unoccluded object.

13. The one or more non-transitory computer-readable media of clauses 11 or 12, where generating the unoccluded object data includes excluding at least one of a first object with one or more visible parts occupying less than a first percentage of an area associated with a third image included in the one or more first images, or a second object with one or more visible parts occupying more than a second percentage of the area associated with the third image included in the one or more first images.

14. The one or more non-transitory computer-readable media of any of clauses 11-13, where generating the one or more synthetic images and the occluded object data includes compositing a foreground object included in the plurality of unoccluded objects and a background object included in the plurality of unoccluded objects to generate at least one synthetic image included in the one or more synthetic images.

15. The one or more non-transitory computer-readable media of any of clauses 11-14, where generating the one or more synthetic images and the occluded object data includes randomly selecting a first object and a second object from the unoccluded object data, and pairing the first object and the second object to generate an occlusion pattern within at least one synthetic image included in the one or more synthetic images.

16. The one or more non-transitory computer-readable media of any of clauses 11-15, where generating the one or more synthetic images and the occluded object data includes normalizing a foreground object and a background object included in the unoccluded object data to a scale, and maintaining a first aspect ratio of the foreground object and a second aspect ratio of the background object within at least one synthetic image included in the one or more synthetic images.

17. The one or more non-transitory computer-readable media of any of clauses 11-16, where the second machine learning model is pre-trained to perform modal mask prediction.

18. The one or more non-transitory computer-readable media of any of clauses 11-17, where the instructions, when executed by the one or more processors, further cause the one or more processors to perform the steps of receiving the second image, detecting, based on the second image, a bounding box associated with an object included in the second image, and generating the second bounding box prompt based on the bounding box.

19. The one or more non-transitory computer-readable media of any of clauses 11-18, where the instructions, when executed by the one or more processors, further cause the one or more processors to perform the steps of receiving a user prompt and the second image, and generating, based on the user prompt, the second bounding box prompt.

20. In some embodiments, a system includes one or more memories storing instructions, and one or more processors that are coupled to the one or more memories and, when executing the instructions, are configured to generate, based on one or more first images and one or more first bounding box prompts, and using a first trained machine learning model, a first predicted amodal mask, generate, based on the first predicted amodal mask, the one or more first images, the one or more first bounding box prompts, and one or more ground truth modal masks, unoccluded object data, generate, based on the unoccluded object data, one or more synthetic images and occluded object data, and perform, based on the one or more synthetic images and the occluded object data, one or more operations to train a second machine learning model to generate a second trained machine learning model, where the second trained machine learning model processes a second image and a second bounding box prompt to generate a second predicted amodal mask.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model for image segmentation, the method comprising:
generating, based on one or more first images and one or more first bounding box prompts, and using a first trained machine learning model, a first predicted amodal mask;
generating, based on the first predicted amodal mask, the one or more first images, the one or more first bounding box prompts, and one or more ground truth modal masks, unoccluded object data;
generating, based on the unoccluded object data, one or more synthetic images and occluded object data; and
performing, based on the one or more synthetic images and the occluded object data, one or more operations to train a second machine learning model to generate a second trained machine learning model,
wherein the second trained machine learning model processes a second image and a second bounding box prompt to generate a second predicted amodal mask.

2. The computer-implemented method of claim 1, wherein generating the unoccluded object data comprises comparing the first predicted amodal mask with a first ground truth modal mask included in the one or more ground truth modal masks to identify an unoccluded object.

3. The computer-implemented method of claim 1, wherein generating the unoccluded object data comprises excluding at least one of:
a first object with one or more visible parts occupying less than a first percentage of an area associated with a third image included in the one or more first images; or
a second object with one or more visible parts occupying more than a second percentage of the area associated with the third image included in the one or more first images.

4. The computer-implemented method of claim 1, wherein generating the unoccluded object data comprises filtering out a class of one or more object categories included in the one or more first images.

5. The computer-implemented method of claim 1, wherein generating the one or more synthetic images and the occluded object data comprises compositing a foreground object included in the plurality of unoccluded objects and a background object included in the plurality of unoccluded objects to generate at least one synthetic image included in the one or more synthetic images.

6. The computer-implemented method of claim 1, wherein generating the one or more synthetic images and the occluded object data comprises:
randomly selecting a first object and a second object from the unoccluded object data; and
pairing the first object and the second object to generate an occlusion pattern within at least one synthetic image included in the one or more synthetic images.

7. The computer-implemented method of claim 1, wherein generating the one or more synthetic images and the occluded object data comprises limiting, within at least one synthetic image included in the one or more synthetic images, a percentage of a first object included in the unoccluded object data that is occluded by a second object included in the unoccluded object data.

8. The computer-implemented method of claim 1, wherein generating the one or more synthetic images and the occluded object data comprises determining, based on one or more geometric rules and one or more spatial rules, at least one of a relative placement, a scale, or a depth ordering associated with one or more objects within at least one synthetic image included in the one or more synthetic images.

9. The computer-implemented method of claim 1, wherein generating the one or more synthetic images and the occluded object data comprises:
normalizing a foreground object and a background object included in the unoccluded object data to a scale; and
maintaining a first aspect ratio of the foreground object and a second aspect ratio of the background object within at least one synthetic image included in the one or more synthetic images.

10. The computer-implemented method of claim 1, wherein generating the one or more synthetic images and the occluded object data comprises randomizing at least one of one or more lighting conditions, one or more camera angles, or one or more object textures within at least one synthetic image included in the one or more synthetic images.

11. One or more non-transitory computer-readable media storing instructions that, when executed by one or more processors, cause the one or more processors to perform the steps of:
generating, based on one or more first images and one or more first bounding box prompts, and using a first trained machine learning model, a first predicted amodal mask;
generating, based on the first predicted amodal mask, the one or more first images, the one or more first bounding box prompts, and one or more ground truth modal masks, unoccluded object data;
generating, based on the unoccluded object data, one or more synthetic images and occluded object data; and
performing, based on the one or more synthetic images and the occluded object data, one or more operations to train a second machine learning model to generate a second trained machine learning model,
wherein the second trained machine learning model processes a second image and a second bounding box prompt to generate a second predicted amodal mask.

12. The one or more non-transitory computer-readable media of claim 11, wherein generating the unoccluded object data comprises comparing the first predicted amodal mask with a first ground truth modal mask included in the one or more ground truth modal masks to identify an unoccluded object.

13. The one or more non-transitory computer-readable media of claim 11, wherein generating the unoccluded object data comprises excluding at least one of:
a first object with one or more visible parts occupying less than a first percentage of an area associated with a third image included in the one or more first images; or
a second object with one or more visible parts occupying more than a second percentage of the area associated with the third image included in the one or more first images.

14. The one or more non-transitory computer-readable media of claim 11, wherein generating the one or more synthetic images and the occluded object data comprises compositing a foreground object included in the plurality of unoccluded objects and a background object included in the plurality of unoccluded objects to generate at least one synthetic image included in the one or more synthetic images.

15. The one or more non-transitory computer-readable media of claim 11, wherein generating the one or more synthetic images and the occluded object data comprises:
randomly selecting a first object and a second object from the unoccluded object data; and
pairing the first object and the second object to generate an occlusion pattern within at least one synthetic image included in the one or more synthetic images.

16. The one or more non-transitory computer-readable media of claim 11, wherein generating the one or more synthetic images and the occluded object data comprises:
normalizing a foreground object and a background object included in the unoccluded object data to a scale; and
maintaining a first aspect ratio of the foreground object and a second aspect ratio of the background object within at least one synthetic image included in the one or more synthetic images.

17. The one or more non-transitory computer-readable media of claim 11, wherein the second machine learning model is pre-trained to perform modal mask prediction.

18. The one or more non-transitory computer-readable media of claim 11, wherein the instructions, when executed by the one or more processors, further cause the one or more processors to perform the steps of:
receiving the second image;
detecting, based on the second image, a bounding box associated with an object included in the second image; and
generating the second bounding box prompt based on the bounding box.

19. The one or more non-transitory computer-readable media of claim 11, wherein the instructions, when executed by the one or more processors, further cause the one or more processors to perform the steps of:
receiving a user prompt and the second image; and
generating, based on the user prompt, the second bounding box prompt.

20. A system, comprising:
one or more memories storing instructions; and
one or more processors that are coupled to the one or more memories and, when executing the instructions, are configured to:
generate, based on one or more first images and one or more first bounding box prompts, and using a first trained machine learning model, a first predicted amodal mask,
generate, based on the first predicted amodal mask, the one or more first images, the one or more first bounding box prompts, and one or more ground truth modal masks, unoccluded object data,
generate, based on the unoccluded object data, one or more synthetic images and occluded object data, and
perform, based on the one or more synthetic images and the occluded object data, one or more operations to train a second machine learning model to generate a second trained machine learning model,
wherein the second trained machine learning model processes a second image and a second bounding box prompt to generate a second predicted amodal mask.
